(19) United States
(12) Patent Application Publication
(10) Pub. No.: US 2026/0171051 A1
(43) Pub. Date: Jun. 18, 2026

(54) SYSTEM AND METHOD FOR DETECTING MUSICAL PERFORMANCE ERRORS

(71) Applicant: Purdue Research Foundation, West Lafayette, IN (US)

(72) Inventors: Benjamin Shiue-Hal Chou, West Lafayette, IN (US); Yung-hsiang Lu, West Lafayette, IN (US); Yeon Ji Yun, West Lafayette, IN (US)

(73) Assignee: Purdue Research Foundation, West Lafayette, IN (US)

(21) Appl. No.: 19/402,762

(22) Filed: Nov. 26, 2025

Related U.S. Application Data
(60) Provisional application No. 63/733,990, filed on Dec. 13, 2024.

(51) Int. Cl. G10H 1/00

(52) U.S. Cl. CPC G10H 1/0008; G10H 2210/091

(57) ABSTRACT

A method of identifying musical performance errors includes receiving a performance audio file associated with a musical performance including possible musical errors, receiving a reference score audio file associated with a baseline performance free of any musical errors, segmenting each of the performance and reference score audio files into a plurality of windows, for each window, applying a model to thereby detect any musical errors that exist between the performance and reference score audio files, and using a visual or audio indicator communicating the detected musical error to a user.

### CROSS-REFERENCE TO RELATED APPLICATIONS

The present non-provisional patent application is related to and claims the priority benefit of U.S. Provisional Patent Application Ser. No. 63/733,990, filed Dec. 13, 2024, the contents of which are hereby incorporated by reference in its entirety into the present disclosure.

### STATEMENT REGARDING GOVERNMENT FUNDING

This invention was made with government support under 2326198 IIS awarded by the National Science Foundation. The government has certain rights in the invention.

### TECHNICAL FIELD

The present disclosure generally relates to a system and method for detecting errors in musical performances.

### BACKGROUND

This section introduces aspects that may help facilitate a better understanding of the disclosure. Accordingly, these statements are to be read in this light and are not to be understood as admissions about what is or is not prior art.

A beginner musician often needs assistance identifying errors in his/her performance. For example, novice musicians may struggle with sight reading or miss notes due to a lack of muscle memory. Access to music education programs which could help address these issues is limited; for example, in the USA alone, approximately 4 million K-12 students do not have access to music education.

To bridge this gap, commercial music tutoring tools have become essential resources. Beginner musicians can practice more effectively, and teachers are provided with insights into students'progress. The significant demand for such automated solutions is evident, with existing application such as Yousician and Simply Piano each having over 10 million downloads globally. However, Simply Piano and Yousician only identify notes as correct or incorrect, without offering detailed feedback such as missed or extra notes. They also lack the ability to automatically align the user's performance with a reference, relying instead on the user to match their performance with the reference performance. Furthermore, their models are not adaptable for use with multiple instruments.

The research community has also attempted to provide fine-grained music performance feedback but has had limited success. A major paradigm of prior work is to temporally align a student's performance with a reference score and then identify differences. These alignment-based approaches often fail when there are deviations in the played notes from the score, even if they are minor. The resulting misalignment of notes leads to inaccurate error detection, and ineffective feedback for students.

Therefore, there is an unmet need for a novel system and a method to detect a musician's errors withhold relying on automatic alignment to a reference performance and to provide an annotated musical score without requiring any manual intervention.

### SUMMARY

A method of identifying musical performance errors, is disclosed. The method includes receiving a performance audio file associated with a musical performance including possible musical errors, receiving a reference score audio file associated with a baseline performance free of any musical errors, and segmenting each of the performance and reference score audio files into a plurality of windows. For each window, the method also includes applying a model to thereby detect any musical errors that exist between the performance and reference score audio files. The method further includes using a visual or audio indicator communicating the detected musical error to a user.

A system of identifying musical performance errors is also disclosed. The system includes an audio input device configured to convert audible sounds to electronic signals presented in one or more audio files. The system also includes a processor executing software housed on a non-transient memory. The execution of the software enables the processor to receive a performance audio file associated with a musical performance including possible musical errors, receive a reference score audio file associated with a baseline performance free of any musical errors, segment each of the performance and reference score audio files into a plurality of windows. For each window, the processor is further configured to apply a model to thereby detect any musical errors that exist between the performance and reference score audio files. The system further includes a visual or audio indicator in communication with the processor to thereby communicate the detected musical error to a user.

### BRIEF DESCRIPTION OF DRAWINGS

FIG. 1 is a high-level block diagram of a model that shows the novel system and method of the present disclosure.

FIG. 2 is a high-level block diagram that describes the optimization process used in training the model of FIG. 1.

FIG. 3 is a block diagram showing an end-to-end model, including patchification, encoder, decoder, thus showing the model of the present disclosure in more detail.

FIGS. 4A and 4B are diagrams which describe patching block and the associated steps, according to the present disclosure, specifically, FIG. 4A describes patching of score representation, and FIG. 4B describes patching of performance representation.

FIG. 5 is a diagram which describes the encoder architecture (dual branch+concatenation), according to the present disclosure.

FIG. 6 is a diagram which describes an example of a transformer block (self-attention+MLP with residuals), according to the present disclosure.

FIG. 7 is a diagram which describes a multi-head self-attention block, according to the present disclosure.

FIG. 8 is a diagram which describes the multi-head self-attention module, according to the present disclosure.

FIG. 9 is a diagram which describes layer normalization block, according to the present disclosure.

FIG. 10 is a diagram which depicts a multi-layer perceptron (MLP) used as the position-wise feed-forward component of a Transformer block, according to the present disclosure.

FIG. 11 is a diagram which describes cross-attention transformer block (decoder block), according to the present disclosure.

FIG. 12 is a diagram which describes a cross-attention head, according to the present disclosure.

FIG. 13 is a diagram which provides a multi-head cross-attention topology, according to the present disclosure.

FIG. 14 is a diagram which provides the full decoder architecture, according to the present disclosure.

FIG. 15A is a diagram which provides details of the encoder, according to the present disclosure.

FIG. 15B is a diagram which provides a detailed view of the decoder architecture, according to the present disclosure.

FIG. 15C is a diagram which provides a summary of the token vocabulary used for both training and inference, according to the present disclosure.

FIG. 16 is a diagram which describes the overall training process for the model of the present disclosure.

FIG. 17 is a diagram which provides an end-to-end flow from interface to user output, according to the present disclosure.

FIG. 18 is a high-level diagram showing the components of an exemplary data-processing system for analyzing data and performing other analyses described herein, and related components.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 15%, within 10%, within 5%, or within 1% of a stated value or of a stated limit of a range.

In the present disclosure, the term “substantially” can allow for a degree of variability in a value or range, for example, within 85%, within 90%, within 95%, or within 99% of a stated value or of a stated limit of a range.

A novel system and a method are disclosed herein to detect a musician's errors without relying on automatic alignment to a reference performance and to provide an annotated musical score without requiring any manual intervention.

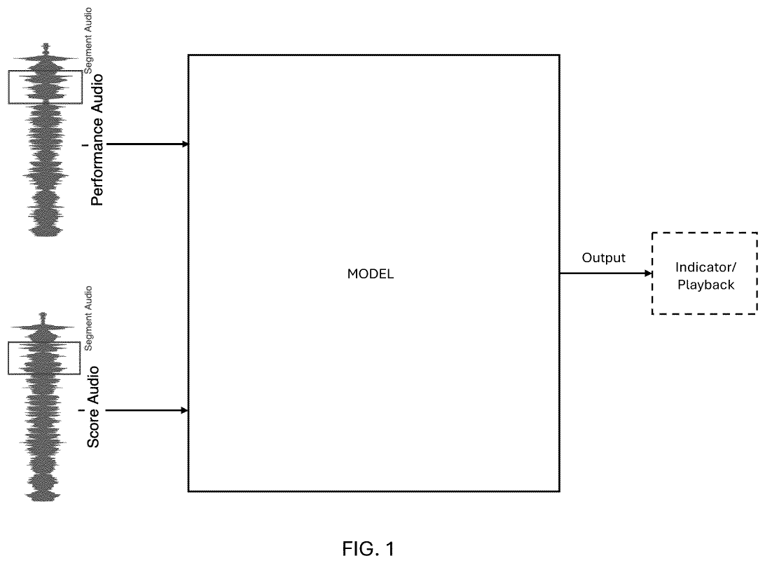

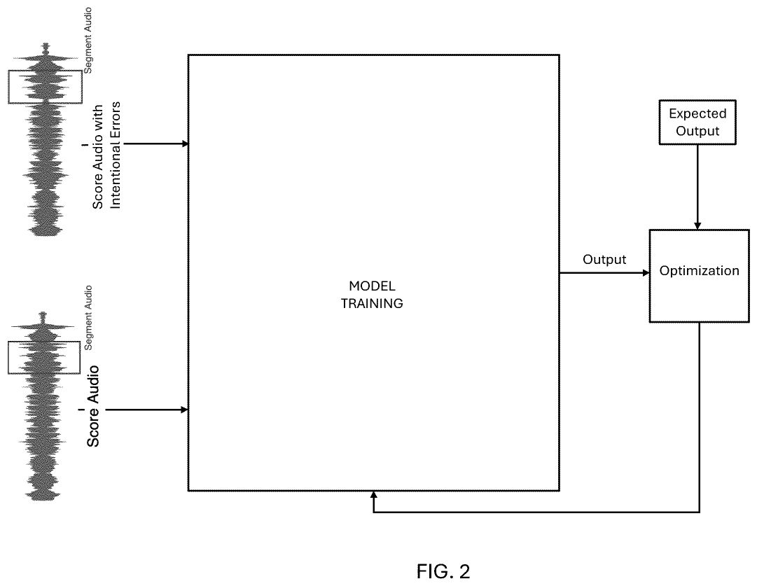

Referring to FIG. 1, a high-level block diagram is provided that shows the novel system and method of the present disclosure. This figure illustrates the high-level system used during inference. A performance audio signal from the user and a reference score (in symbolic or audio form) are provided as inputs to the model. The model compares the two inputs and produces diagnostic outputs indicating timing and pitch errors, extra and missed notes, or other performance deviations. These outputs are then rendered to the user through indicators (e.g., a score display with highlighted errors, textual feedback) and/or playback (e.g., audio with emphasized error regions). Except for the specific way the two streams (score and performance) are paired and interpreted for music-error feedback, the internal encoder-decoder machinery of the model may follow a conventional attention-based sequence transduction architecture, such as the Transformer encoder-decoder described in U.S. Pat. No. 10,452,978 B2 (“Attention-based sequence transduction neural networks,” incorporated by reference into the present disclosure in its entirety, see, e.g., FIGS. 1-3). As shown, a model, according to the present disclosure, receives two audio files (i.e., amplitude vs. time), one file associated with the musician's performance and one as a reference score audio file. Each of these files provide an amplitude, e.g., in volts, vs. time, e.g., in seconds. The model is trained vis-à-vis a plurality of parameters, described further below and with reference to FIG. 2. With the two audio files as input, the model generates an output. The output can be in the form of tokens which indicate for each segment of audio files, e.g., a window between about 10 ms to about 2 seconds, whether the musician erroneously played an extra note, missed a note, or correctly played the segment. The output may be provided immediately after an error has occurred during said window, or alternatively after the termination of said window. The output may be provided in the form of vocabulary on an input/output device, e.g., a computer monitor, or in the form of a visual or audio feedback, e.g., lights, e.g., a red light for a missed note, a yellow light for an extra note, and a green light for a correct note. The indicator lights may be activated a short period of time, e.g., during said window and toggle back-and-forth between, e.g., green and red/yellow. Alternatively an audio indicator may be activated, e.g., a one second beep to indicate a missed note, a half second beep to indicate an extra note, and otherwise, no audio feedback if the correct notes are played. In addition, and optionally, the system shown in FIG. 1, may be configured to at the completion of the performance playback portions of the performance by the musician with errors based on a selective window around where the error was made along with the correct audio portion based on the reference score audio file in order to make a direct comparison between the performance and the score inputs.

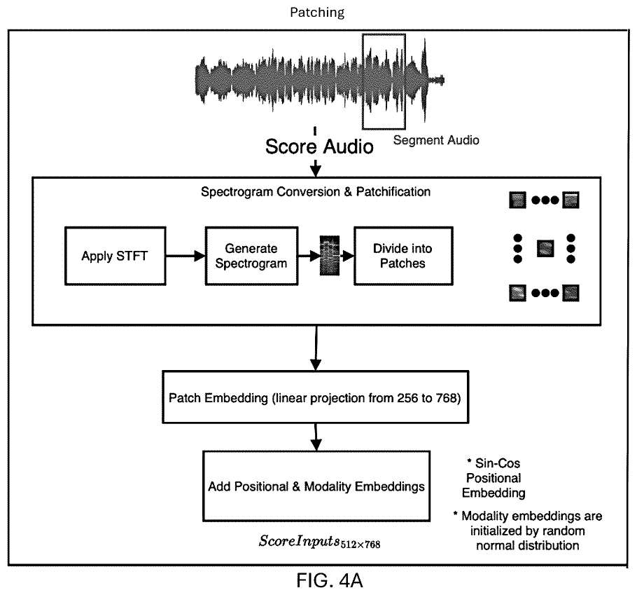

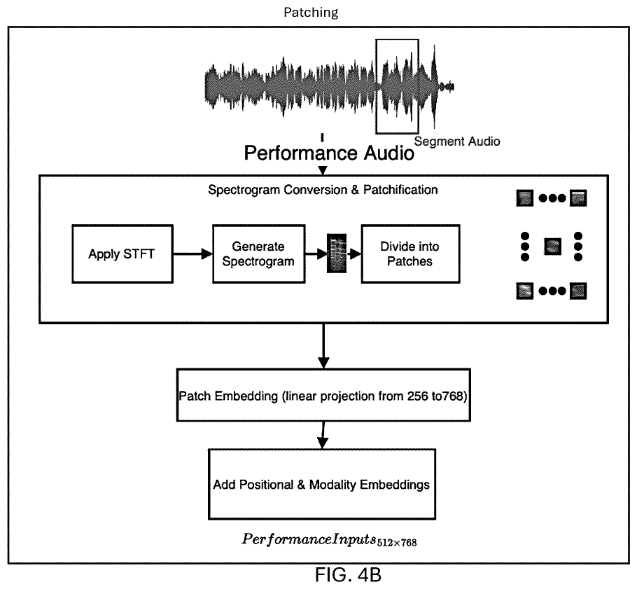

As indicated above, the model shown in FIG. 1 is a trained model based on a plurality of trainable parameters. Referring to FIG. 2, a high-level block diagram is shown to describe the optimization process used in training the model. This figure shows the training process. Symbolic score data are converted into score audio using a synthesizer. Intentional mistakes are introduced into the symbolic score (e.g., including pitch shifts, timing shifts, missed notes, and extra notes) to form a corresponding “performance” version, which is likewise synthesized into performance audio. Both score audio and performance audio are then converted into time-frequency representations and patchified, as described with reference to FIGS. 4A-4B. The patchified inputs are fed into the model, which predicts a sequence of vocabulary tokens describing note events and error labels. Ground-truth performance errors are converted into the same token format using a predefined vocabulary. A cross-entropy loss (optionally class-weighted to emphasize error tokens) is computed between the predicted and ground-truth token sequences. The loss is backpropagated through the encoder-decoder network, and the model parameters are updated using gradient-based optimization until the loss is minimized or a stopping criterion is reached. The training setup itself (teacher-forced sequence prediction with a cross-entropy loss over vocabulary tokens) can follow standard Transformer training practice as described for example in U.S. Pat. No.10,452,978 B2 (e.g., encoder 110, decoder 150, linear layer 180 and softmax layer 190).

Similar to FIG. 1, two audio files are input, with one being a reference audio score file and the other being the same file but with intentional errors introduced therein. These two files are repeatedly input to the model, and the output of the model is compared with the expected output. Where there are differences between the model's output and the expected output, the model is optimized to minimize said differences through an optimization process, e.g., a gradient descent, known to a person having ordinary skill in the art.

Synthetic performance errors are generated by selecting notes from a reference score according to a Poisson process with a configurable rate parameter. For each selected note, an error type is sampled from a set including missed note, pitch-changed note, timing-shifted note, and extra note. For pitch-changed and timing-shifted errors, the pitch and onset time of the note are perturbed by random offsets drawn from truncated normal distributions. For extra notes, a new note is inserted at a perturbed pitch and onset time. The resulting modified score is then converted to audio to form the performance signal.

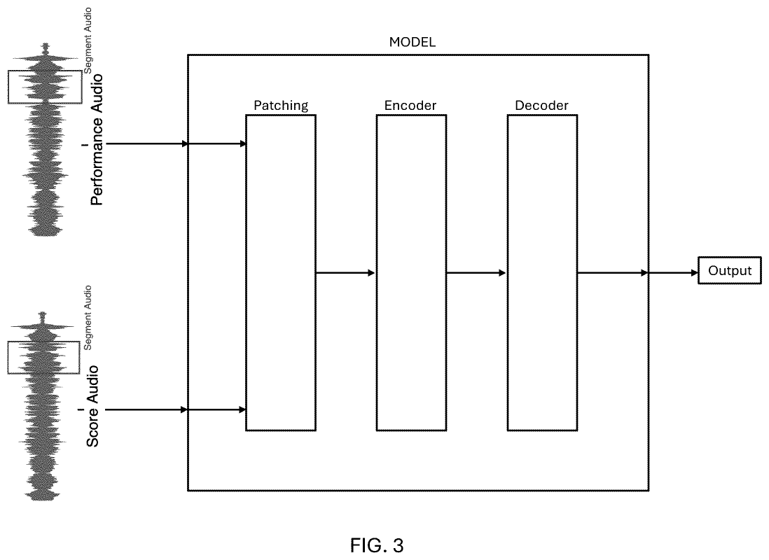

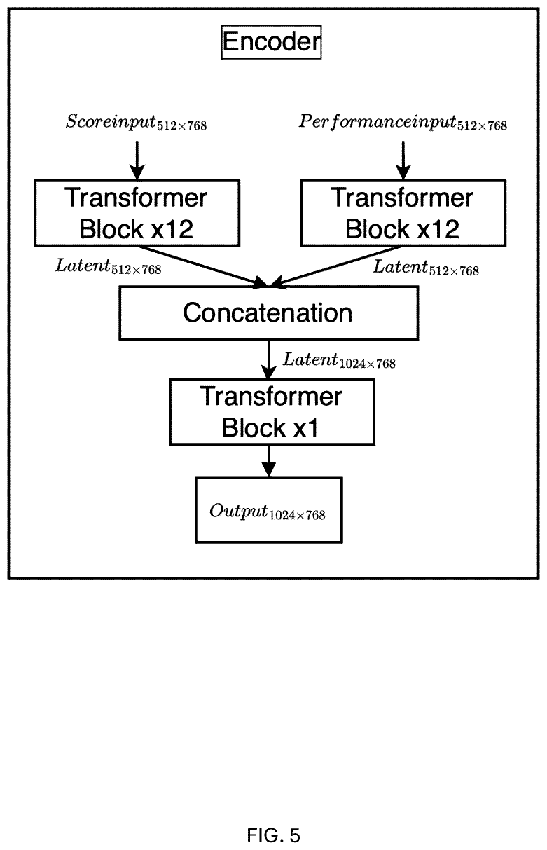

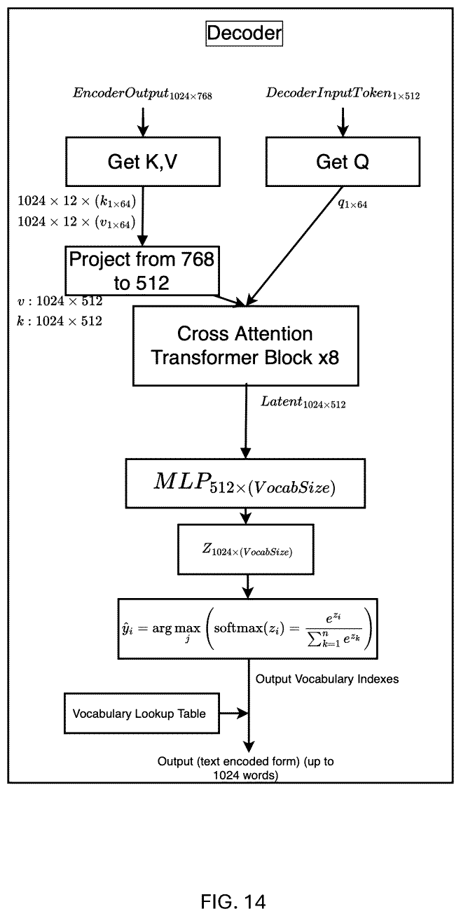

Referring to FIG. 3, a block diagram is provided showing an end-to-end model, including patchification, encoder, decoder, thus showing the model of the present disclosure in more detail. The model includes three major blocks: a patching block, an encoder, and a decoder. The audio files are first provided to the patching block which provides inputs to the encoder, which provides inputs to the decoder. The decoder generates the model's output. This figure connects the three main stages of the model: input patchification, encoder, and decoder. Audio waveforms for the score and performance are segmented into short windows, converted to spectrograms, and patchified as shown in FIGS. 4A-4B, discussed further below. The resulting score and performance patch sequences are processed by the encoder (see FIG. 5, discussed below), which outputs a unified latent representation that jointly encodes the two inputs. The decoder (see FIG. 14, discussed below) then autoregressively generates a sequence of vocabulary tokens describing note events and error labels, conditioned on the encoder outputs. The patchification stage is analogous to the vision-transformer patch embedding stage described in U.S. Pat. No. 12,154,307 B2 (“Interpretability-aware redundancy reduction for vision transformers”), incorporated by reference into the present disclosure in its entirety, in which an image is divided into fixed-size patches, each patch is linearly embedded into a token, and positional embeddings are added. The encoder-decoder stack may be implemented using a standard Transformer architecture such as that in U.S. Pat. No. 10,452,978 B2.

Referring to FIGS. 4A and 4B, the patching block and the associated steps are shown. Specifically, FIG. 4A describes patching of score representation. This figure illustrates patchification of a time-frequency representation for the score stream. The input is a two-dimensional spectrogram (optionally with multiple channels, such as magnitude and additional score-aligned features). The spectrogram is partitioned into non-overlapping 16×16 patches along the time and frequency axes. Each patch is flattened into a 1×256 vector and passed through a learnable patch-embedding layer to produce a 1×768 embedding. A fixed sinusoidal positional embedding of size 1×768 and a learned embedding of size 1×768 are added to each patch embedding. The result is a sequence of 512 score patch embeddings of dimension 768, denoted ScoreInput₅₁₂×₇₆₈. This patch-based tokenization closely mirrors the patch embedding stage of a vision transformer as described, for example, in U.S. 12,154,307 B2 where an image is split into fixed-size patches that are linearly embedded into tokens and augmented with positional encodings before being processed by self-attention layers.

The input processing begins by segmenting the audio waveform into 2.045-second segments, although other window segmentation are possible. Each segment undergoes a short-time Fourier transform (STFT) to generate a spectrogram, i.e., a graph of frequency vs. time. The spectrogram is divided into 16 x16 patches, which are flattened into vectors of size 1×256. While vector sizes are discussed herein, it should be appreciated that no limitations are intended thereby and other numbers, e.g., number of patches, etc., are well within the ambit of the present disclosure. These vectors are then transformed through a patch embedding layer, resulting in embeddings of size 1×768 (i.e., a projection from 1×256 to 1×768 via a projection matrix T, i.e., A_{1×256} X T_{256×768}=B_{1×768}, where T is a randomly chosen matrix that is optimized based on the optimization process discussed with reference to FIG. 2). A sinusoidal positional embedding of size 1×768 and a randomly initialized vector of size 1×768 are added to each embedded patch. This produces the final input representations: a score input patch of size 512×768 and performance input patches of size 512×768.

FIG. 4B provides patching of performance representation. This figure shows the analogous patchification process for the performance stream. As described above, the performance audio is converted to a time-frequency representation (e.g., a spectrogram) that is divided into 16×16 patches. Each patch is flattened to a 1×256 vector and passed through the same or a similar patch-embedding layer to produce 1×768 embeddings. Sinusoidal and learned positional embeddings are added, yielding a sequence of 512 performance patch embeddings of dimension 768, denoted PerformanceInput₅₁₂×₇₆₈. As in FIG. 4A, this patchification follows the general pattern of vision-transformer patch embedding described in U.S. Pat. No. 12,154,307 B2, with the difference that the input is a time-frequency audio representation rather than an image. The dual-stream design (separate patch sequences for score and performance) is specific to this music-error detection application.

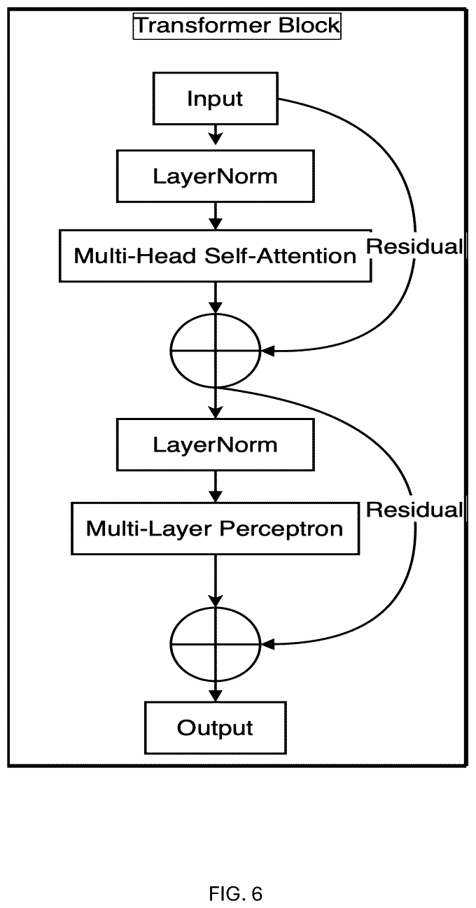

The encoder shown in FIG. 3, is further discussed below with reference to FIG. 5, providing encoder architecture (dual branch+concatenation). This figure provides a detailed breakdown of the encoder. Patchified score inputs (ScoreInput₅₁₂×₇₆₈) and patchified performance inputs (PerformanceInput₅₁₂×₇₆₈) are processed in parallel by two separate stacks of Transformer blocks. Each stack contains twelve Transformer blocks as described in FIG. 6. The score branch produces a latent score sequence of shape 512×768, and the performance branch produces a latent performance sequence of shape 512×768.

The two latent sequences are concatenated along the sequence dimension to form a unified latent representation of shape 1024×768. This concatenated sequence is then passed through a further Transformer block, resulting in an encoder output of shape 1024×768 that jointly encodes both the score and performance streams. This unified representation is supplied to the decoder.

As discussed above, the encoder's structure (stacked self-attention/MLP blocks with residual connections and layer normalization) can follow a conventional Transformer encoder architecture as in U.S. Pat. No. 10,452,978 B2 (encoder 110 and encoder subnetworks 130) (repeated self-attention and transition functions).

The encoder architecture processes patchified inputs from two modalities: score input and performance input. Each modality undergoes independent processing through a dedicated series of 12 Transformer Blocks. The score input patches, sized 512×768, and the performance input patches, also sized 512×768, are transformed into latent representations of the same dimensions within their respective branches. The latent representations from both branches are concatenated along the sequence dimension, resulting in a unified latent representation with dimensions 1024×768. This combined representation undergoes further processing through a single Transformer Block. The final output of the encoder, sized 1024×768, effectively integrates information from both the score and performance inputs.

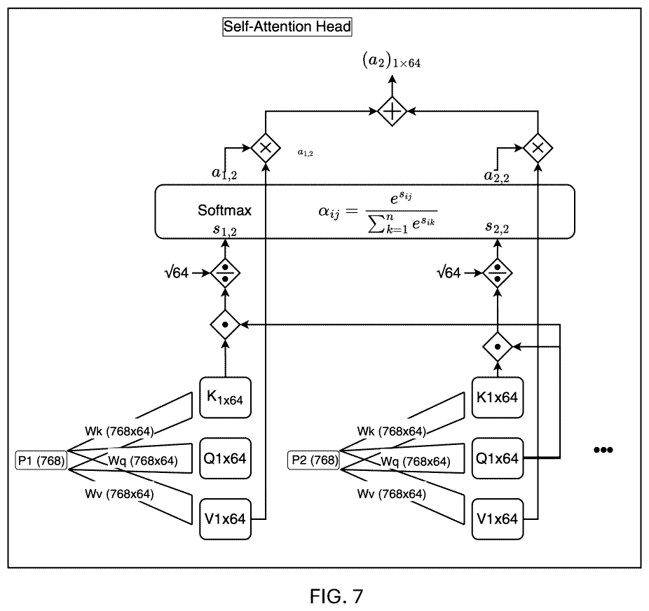

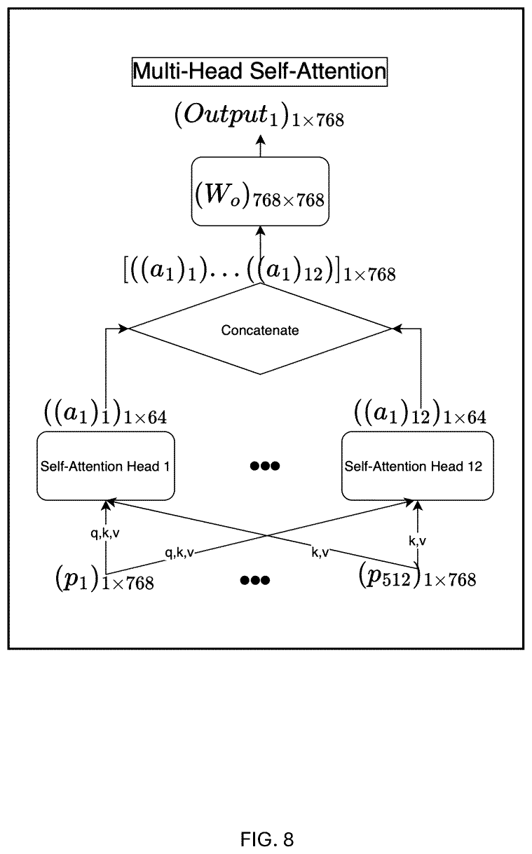

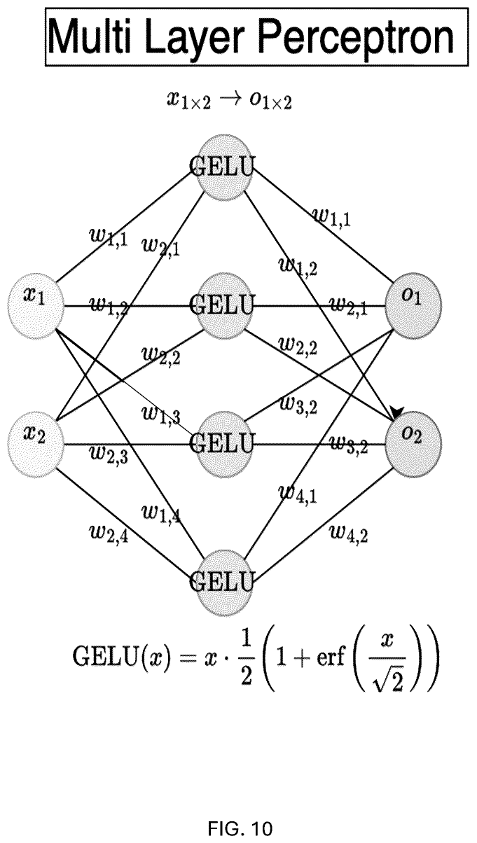

Referring to FIG. 6, an example of the transformer block (self-attention+MLP with residuals) shown in FIG. 5 is provided. This figure illustrates a single Transformer block used in both the encoder and decoder. The block receives an Input sequence and produces an Output sequence of the same shape. First, layer normalization is applied to the Input. The normalized sequence is passed through a multi-head self-attention module (see FIGS. 7-8, described below). The attention output is added back to the original Input via a residual connection. The result is normalized again and passed through a position-wise multi-layer perceptron (MLP) as described in FIG. 10, described below. The MLP output is added to its own input via a second residual connection to form the block Output. This structure corresponds to the standard “attention +feed-forward” Transformer block with residual and layer-normalization layers.

Blocks of this form are described in U.S. Pat. No. 10,452,978 B2 (encoder/decoder subnetworks composed of self-attention and position-wise feed-forward layers with residuals and layer normalization.

The input passes through a layer normalization step, followed by a multi-head self-attention. The output of the self-attention layer is added back to the input via a residual connection. Another layer normalization step processes the residual sum, followed by a feed-forward network, or multi-layer perceptron (MLP). The output of the MLP is again added back to the input via a residual connection, forming the final output.

Referring to FIG. 7, the multi-head self-attention block is further described. This figure details a single self-attention head. For each input token representation P (e.g., 1×768), three learned linear projections are applied to obtain query (Q), key (K), and value (V) vectors of dimension 64. For a given query position, the head computes similarity scores as dot products between the query and each key. Each score is scaled by 1/√64 to control the magnitude. A softmax function is applied across the scaled scores to produce attention weights αᵢⱼ. The output for the query position is the weighted sum of the value vectors, Σⱼ αᵢⱼ Vⱼ, producing a vector a of dimension 64. This is the output of the self-attention head for that position. Scaled dot-product attention with Q, K, V projections and softmax weighting over values is the standard mechanism described in U.S. Pat. No. 10,452,978 B2 for attention sublayers in Transformer encoders and decoders (see, e.g., the discussion of attention mechanisms associated with FIG. 2 in the '978 reference).

The self-attention head operates by projecting the input vector into three distinct spaces: query, key, and value. Each projection involves a learned linear transformation that reduces the input vector of size d_model to a smaller dimension d_k. The query and key vectors are used to compute a similarity score for each pair of tokens, defined as the dot product between the query of one token and the key of another. To stabilize training, this score is divided by the square root of d_k. The resulting similarity scores are normalized using the softmax function, which converts them into attention weights a_i, j. These weights determine the relevance of each token to the token being processed. The attention weights are then multiplied by the corresponding value vectors from each token, and the weighted sum of these value vectors produces a_j, the output of token j. Multi-head self-attention combines multiple self-attention heads. Each head computes attention weights and produces its own output. These outputs are concatenated and passed through a linear projection to produce the final multi-head self-attention output as provided in FIG. 8. This figure shows the multi-head self-attention module. The module receives a sequence of token representations (p₁ . . , p₅₁₂), each of dimension 768. A set of self-attention heads (for example, twelve heads) are applied in parallel to the sequence. Each head implements the single-head mechanism of FIG. 7, producing a 64-dimensional output vector for each token position. For each position, the outputs from all heads are concatenated into a 768-dimensional vector. A learned output projection W₀ of shape 768×768 maps the concatenated vector back into the model dimension, producing a multi-head self-attention output for that position. The collection of outputs across positions forms the output sequence of the multi-head self-attention module. This multi-head pattern (multiple attention heads, concatenation, and a final linear projection) mirrors the multi-head attention mechanism used in the encoder and decoder self-attention layers of U.S. Pat. No. 10,452,978 B2(see, for example, the encoder self-attention sub-layer 132 and its associated description).

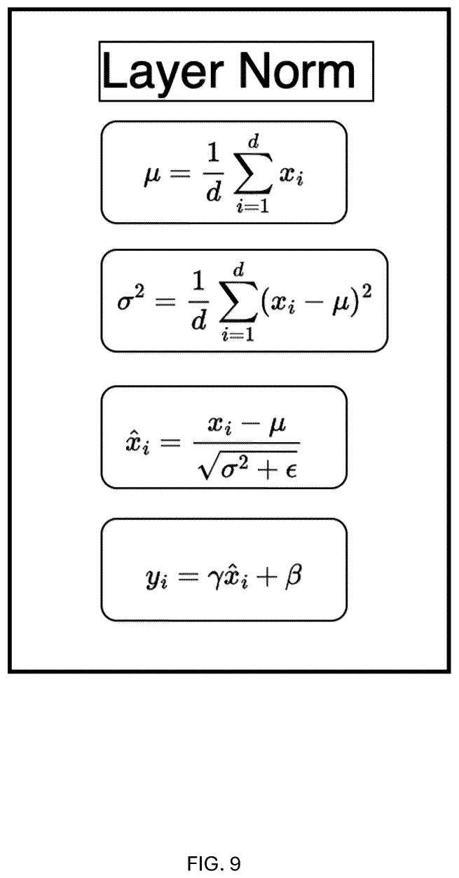

The layer normalization block is discussed with reference to FIG. 9. This figure illustrates layer normalization as applied within Transformer blocks. For each token position, given an input vector x=(x₁, . . . , x_d), the mean μ and variance σ² across the embedding dimension are computed. Each component is normalized as

$${\hat{x}}_{i} = ( {x}_{i} - μ ) / √ ( {σ}^{2} + ε ) ,$$

where ε is a small constant for numerical stability. Learnable scale and shift parameters γ and β are then applied to obtain yᵢ=γ\hat{x}ᵢ+β. The vector y is the layer-normalized output for that token. Layer normalization is used before attention and MLP sublayers in both encoder and decoder blocks. Its use in conjunction with residual connections is consistent with the layer-normalization layers described in U.S. Pat. No. 10,452,978 B2 for encoder and decoder subnetworks (where layer normalization is applied after residual connections) and in related transformer literature referenced therein.

Layer normalization stabilizes training by normalizing the input features across the embedding dimension. The normalization process involves computing the mean and variance of the input, then scaling and shifting the normalized values using learnable parameters.

The Multi-layer perceptron (position-wise feed-forward network), MLP, is further discussed with reference to FIG. 10. This figure depicts a multi-layer perceptron (MLP) used as the position-wise feed-forward component of a Transformer block. For each token position, the MLP takes an input vector x, applies a first learned linear transformation to obtain h=W₁x+b₁, applies a non-linear activation such as GELU to h, and then applies a second learned linear transformation o=W₂ GELU(h)+b₂ to produce an output o of the same dimension as x. The same MLP (same parameters W₁, W₂, b₁, b₂) is applied independently to each token position. This is the standard position-wise feed-forward layer described in U.S. Pat. No. 10,452,978 B2 (position-wise feed-forward sublayer 134/176), where each position is independently transformed by a two-layer feed-forward network with a non-linear activation between the layers.

Generally, the MLP component is a non-linear feed-forward network that processes the output of the layer normalization. It includes two linear projections with a non-linearity. Here we use GELU. In the provided example, the MLP processes an input vector of size 2 and outputs a vector of size 2.

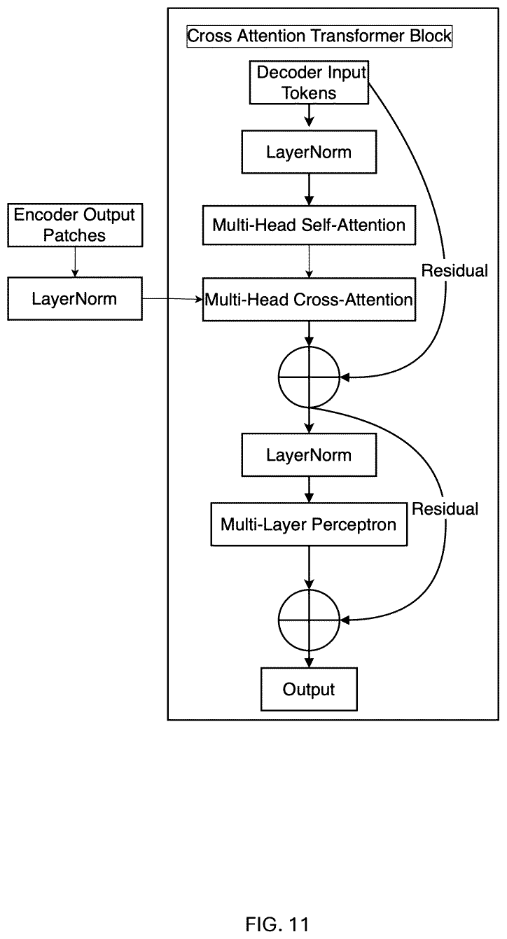

The decoder shown in FIG. 3, is further described with reference to FIGS. 11-14. The decoder begins by embedding the decoder input tokens, which pass through a layer normalization step and a multi-head self-attention layer, as shown in FIG. 11, which depicts cross-attention transformer block (decoder block). This figure shows a Transformer block used in the decoder that incorporates both self-attention and cross-attention. Embedded decoder input tokens are first processed by layer normalization and a multi-head self-attention module, followed by a residual connection. The resulting sequence is normalized again and used to form query vectors.

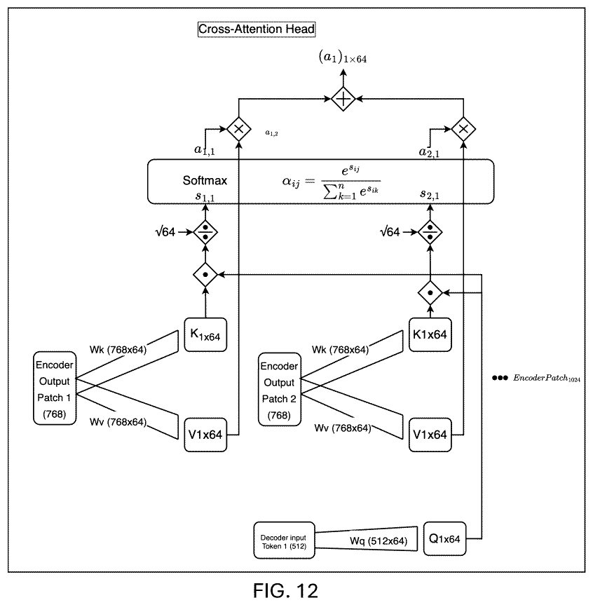

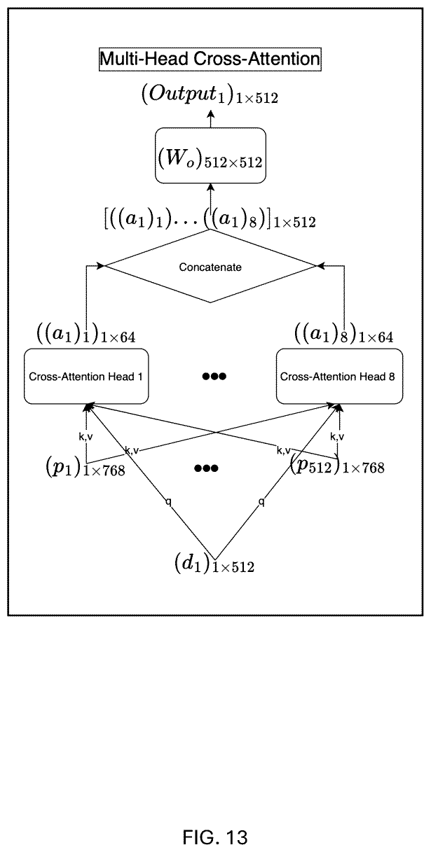

In parallel, the encoder output patches are normalized and used to form key and value vectors. A multi-head cross-attention module then computes attention from each decoder position over all encoder positions, as detailed in FIGS. 12-13, described further below. The cross-attention output is combined with its input by a residual connection. The result is normalized and passed through a position-wise MLP (see FIG. 10, described above), with another residual connection applied to form the block output.

This “self-attention+encoder−decoder attention+feed-forward” decoder-block structure matches the standard decoder subnetwork described in U.S. Pat. No. 10,452,978 B2 (e.g., decoder subnetworks 170 including decoder self-attention sub-layer 172, encoder-decoder attention sub-layer 174, and position-wise feed-forward layer).

The output shown in FIG. 11 is then fed into a multi-head cross-attention layer, which attends to the encoder outputs. The resulting output undergoes layer normalization and a feed-forward network (MLP), with residual connections applied at each step. The cross-attention Transformer Blocks have an extra Multi-Head Cross-Attention layer. These blocks are also made of many Cross Attention heads, an example of which is shown in FIG. 12, depicting a cross-attention head. This figure details a single cross-attention head used within the decoder. A decoder token (e.g., d₁ of dimension 512) is projected by a learned query matrix W_q (512×64) to produce a query vector Q of dimension 64. Each encoder output patch (e.g., p₁ . . . p₅₁₂ of dimension 768) is projected by key and value matrices W_k and W_v (each 768×64) to produce key vectors K and value vectors V of dimension 64.

The head computes scaled dot-product attention scores between the query and each key, sⱼ=(Q·Kⱼ)/√64, applies softmax to obtain attention weights over encoder positions, and forms a weighted sum of the value vectors to produce an output vector a of dimension 64. As in FIG. 7, described above, this is scaled dot-product attention, but with queries from the decoder stream and keys/values from the encoder stream. This corresponds to the encoder-decoder attention mechanism described in U.S. Pat. No. 10,452,978 B2, where the decoder subnetwork uses queries derived from decoder states to attend over encoder outputs treated as keys and values.

In the cross-attention head, the query vectors (Q) are derived from the decoder inputs, while the key (K) and value (V) vectors are computed from the encoder outputs. The dot product of Q and K is scaled by the square root of the feature dimension and normalized via softmax, resulting in attention weights. These weights are then applied to V, producing the output of the cross-attention layer.

Similar to multi-head self-attention, the cross-attention mechanism employs multiple heads to capture different aspects of the relationships between the encoder outputs and decoder inputs. Each head processes a distinct set of Q, K, and V vectors, where K and V come from encoder outputs and Q comes from the decoder input token. The head outputs are then concatenated and linearly projected to form the final cross-attention output, as shown in FIG. 13, depicting a multi-head cross-attention block diagram. This figure shows the multi-head cross-attention module in the decoder. A sequence of decoder token representations (d₁ . . . d₅₁₂, each 512-dimensional) serves as query input, and a sequence of encoder patch representations (p₁ . . . p₅₁₂) each 768-dimensional) serves as key/value input. Multiple cross-attention heads (for example, eight heads) are applied in parallel. Each head is implemented as in FIG. 12, described above, producing a 64-dimensional output for each decoder position. For each position, the outputs from all heads are concatenated into a 512-dimensional vector, which is then mapped by a learned output projection W₀ (512×512) to produce the final cross-attention output for that position. The outputs over all positions form the output sequence of the multi-head cross-attention module. This is analogous to the same multi-head pattern as self-attention in U.S. Pat. No. 10,452,978 B2, but with keys and values taken from the encoder outputs (encoder-decoder attention sub-layer 174).

Thus, the resulting decoder, shown in FIG. 14, obtains K and V vectors from the encoder outputs and Q vectors from the decoder input tokens. This figure illustrates the full decoder architecture. The encoder output sequence (1024×768) is first projected to obtain key and value vectors of dimension 512 for use in cross-attention. Decoder input tokens (e.g., special start tokens followed by previously generated tokens) are embedded to 512-dimensional vectors and projected to obtain query vectors. The decoder applies a stack of cross-attention Transformer blocks (e.g., eight blocks of the form shown in FIG. 11). The stack processes the decoder inputs using self-attention and cross-attention to the encoder outputs, yielding a latent sequence of decoder representations of shape 1024×512. A final linear projection maps each latent vector to a vector of logits over a vocabulary of size V_vocab. A softmax layer converts the logits to probabilities, and a decoding procedure (e.g., argmax or sampling) selects output vocabulary indices, which are mapped through a vocabulary table to obtain the output token sequence. This architecture is consistent with the decoder described in U.S. Pat. No. 10,452,978 B2, in which a sequence of decoder subnetworks 170 is followed by a linear projection 180 and a softmax layer 190 to produce a probability distribution over discrete output symbols at each generation step

We perform Cross-attention transformer blocks 8 times and the output of the decoder is projected through a vocabulary layer, converted to probabilities via softmax, and decoded into the target sequence.

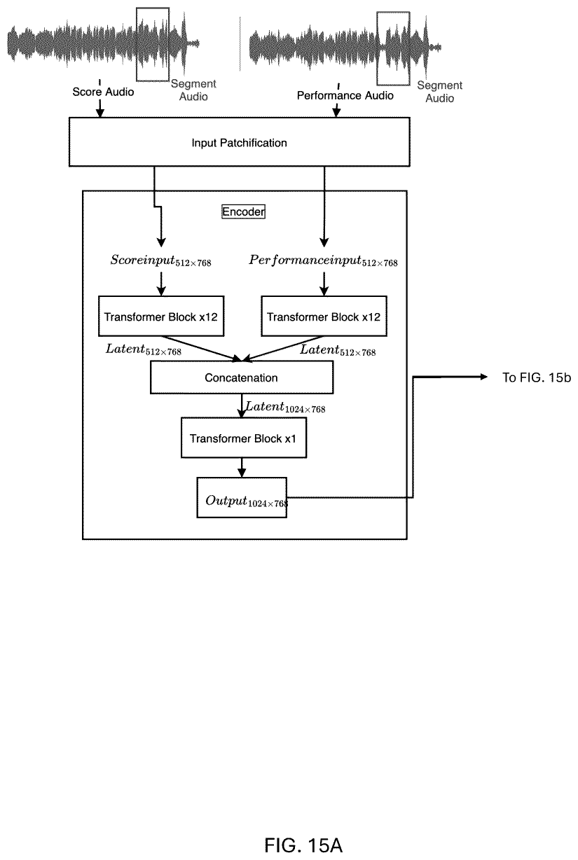

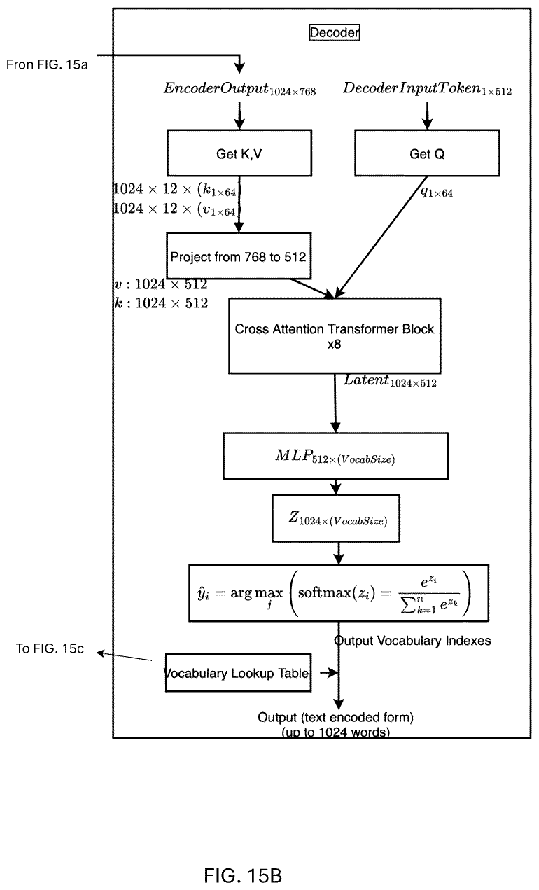

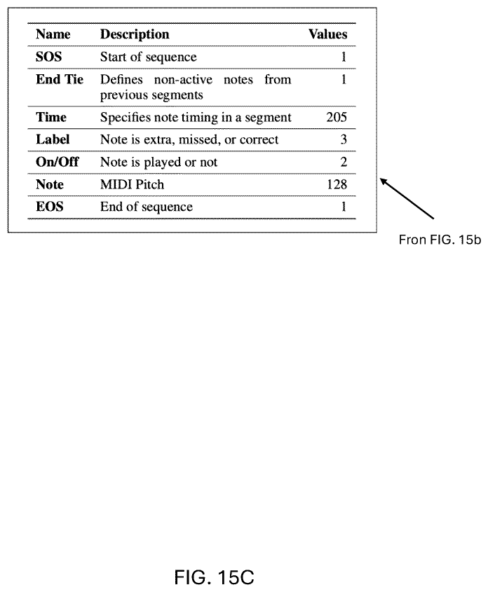

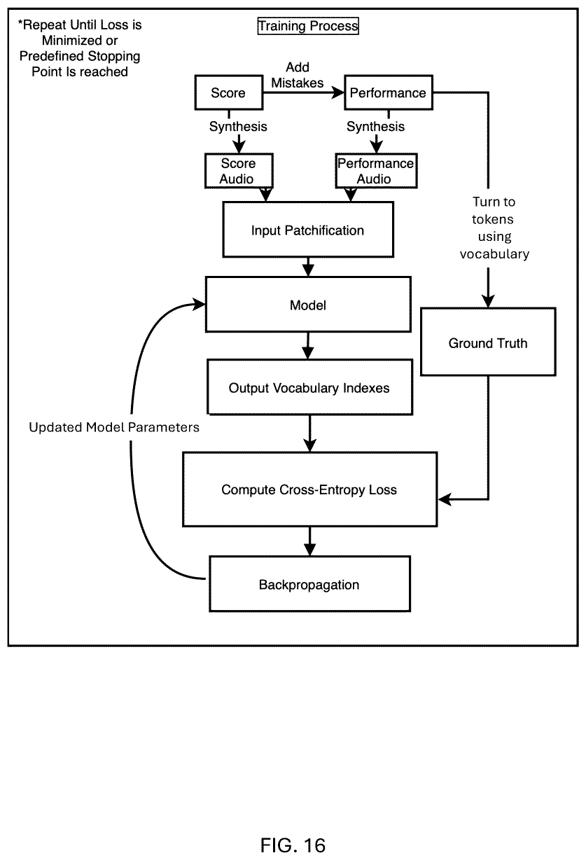

FIGS. 15A, 15B, and 16C graphically put together the patchification block, the encoder block, and the decoder block and how these blocks are coupled to each other. Specifically, FIG. 15A details the encoder. This figure provides a detailed view of the encoder architecture. Patchified score inputs (ScoreInput) and patchified performance inputs (PerformanceInput) are first embedded as in FIGS. 4A-4B, described above. Each stream is then processed by its own stack of Transformer blocks (see FIGS. 6-10, described above), producing a latent score sequence and a latent performance sequence of the same embedding dimension. The two latent sequences are concatenated along the sequence dimension to form a unified latent representation. This concatenated sequence is further processed by one or more Transformer blocks to produce the encoder output. The encoder output serves as the key-value memory that the decoder attends to when generating diagnostic tokens. The internal block structure (multi-head self-attention, position-wise feed-forward, residual connections, and layer normalization) can follow the standard Transformer encoder design described in U.S. Pat. No. 10,452,978 B2 (attention-based sequence transduction neural networks).

FIG. 15B details the decoder. This figure provides a detailed view of the decoder architecture. Decoder input tokens (e.g., start-of-sequence and previously generated tokens) are embedded into vectors and supplied as query inputs. The encoder output sequence from FIG. 15A is projected to obtain key and value vectors. The decoder applies a stack of decoder blocks of the form shown in FIGS. 11-14, described above. Each block includes self-attention over the decoder tokens, cross-attention over the encoder outputs, and a position-wise feed-forward network, with residual connections and layer normalization at each stage. The final decoder layer produces a latent representation at each output position. A linear projection maps each latent vector to logits over a discrete vocabulary of note and error tokens, followed by a softmax to obtain probabilities. A decoding procedure (e.g., argmax) selects token indices, which are mapped through a vocabulary table to obtain the output sequence. This encoder-decoder decoding structure is consistent with the Transformer decoder described in U.S. Pat. No. 10,452,978 B2 (decoder 150, decoder subnetworks, linear layer, and softmax).

FIG. 15C describes token vocabulary. This figure summarizes the token vocabulary used for both training and inference. The vocabulary includes symbols for note events (e.g., pitch classes, onset markers, sustain markers), score-position indicators, and error labels (e.g., missed note, extra note, early/late onset, pitch error). Each token is mapped to a unique index, and during training the model predicts sequences of these indices at the decoder output. By representing musical events and performance errors as discrete tokens, the model can be trained using standard sequence-to-sequence objectives (cross-entropy over vocabulary distributions), as is common in Transformer-based sequence transduction models such as those described in U.S. Pat. No. 10,452,978 B2. The vocabulary also provides a stable interface between the model and downstream components that interpret or visualize the diagnostic output.

FIG. 16 details the training process. This figure illustrates the overall training process for the model of the present disclosure. Symbolic score data are used to synthesize a reference score audio stream. Intentional perturbations are applied to the score (e.g., removing notes, adding extra notes, shifting pitches, shifting onset times) to generate corresponding performance data with known errors, which are synthesized into a performance audio stream. Both the score and performance audio are converted into time-frequency representations and patchified as described in FIGS. 4A-4B. The patchified score and performance inputs are processed by the encoder-decoder model (FIGS. 15A-15B) to produce logits over the token vocabulary (FIG. 15C) at each decoder step. Ground-truth error annotations are converted into token sequences using the same vocabulary. A cross-entropy loss is computed between the predicted and ground-truth token sequences and backpropagated to update model parameters via gradient-based optimization. This training setup mirrors the teacher-forced sequence prediction framework commonly used for Transformer encoder-decoder models such as those in U.S. Pat. No. 10,452,978 B2.

The training process alluded to above, is further described with reference to FIG. 16. The training process depicted in the figure involves synthesizing and processing audio inputs derived from both score and performance data. First, the score data undergoes a synthesis step to generate corresponding score audio, while the performance data is synthesized to produce performance audio. Intentional mistakes are introduced into the score data to obtain the performance data. Both the score audio and performance audio are then patchified.

Above figures also show the output tokens, i.e., one form of output of the present system and method. Three labels are generated: i) extra note, ii) missed note, and iii) correct note. A finer granulations may also be chosen where instead of a yes/no as to whether a note was completely missed and another note played, instead a label with a closeness degree may be used. For example, instead of having three labels, the system could output 9 labels (three for each of extra, missed, and correct) signifying closeness of the error to the correct note.

The patchified inputs are fed into the remainder of the model, which processes them and outputs vocabulary indexes representing predicted tokens. These predicted tokens are compared to the ground truth tokens—the expected performance errors—by converting the ground truth into token representations using a predefined vocabulary. A cross-entropy loss is computed based on the discrepancy between the predicted vocabulary indexes and the ground truth. This loss is then backpropagated through the model to update its parameters. The process repeats iteratively until the loss is minimized or a predefined stopping criterion is reached.

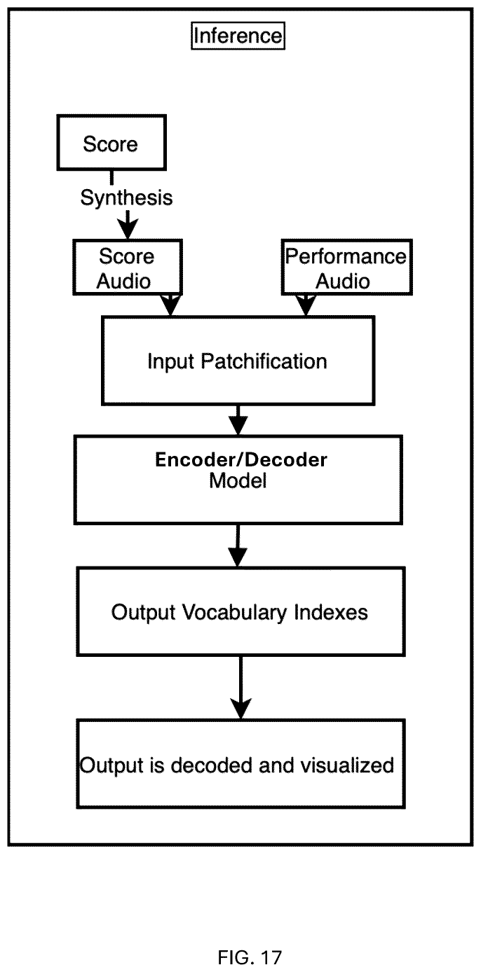

During actual use of the model (inference), the following process is carried out: When using the model with an actual performance (inference), the process begins with the score data and performance audio inputs. The score data is synthesized into its corresponding score audio, while the performance audio is directly provided. Both audio inputs are then patchified, as shown in FIG. 17, which provides an end-to-end flow from interface to user output. This figure presents an end-to-end view of how the system is used in practice, from user interface to final feedback. A reference score (symbolic) is provided or selected in the interface, and either synthesized or recorded score audio is obtained. A user performs the piece, and their performance audio is captured. Both audio streams are preprocessed and patchified (FIGS. 4A-4B) and passed through the encoder-decoder model (FIGS. 15A-15B). The decoder outputs a sequence of tokens from the vocabulary (FIG. 15C), which are decoded into structured diagnostic information: for example, which notes were missed, which were extra, which were early or late, and where pitch deviations occurred. This information is then rendered back to the user through visual indicators (e.g., an annotated score display) and/or audio playback with highlighted error regions. Internally, the sequence modeling and attention mechanisms follow the general Transformer encoder-decoder framework of U.S. Pat. No. 10,452,978 B2, while the specific token design and pairing of score and performance streams are tailored to music performance error detection.

These patchified inputs are fed into the remainder of the model, which processes them and generates output vocabulary indexes. These indexes represent the model's predicted tokens in a vocabulary-based format. The predicted tokens are then decoded to reconstruct the output in text form. Finally, the output is visualized or audiolized as discussed above, allowing users to interpret the results effectively.

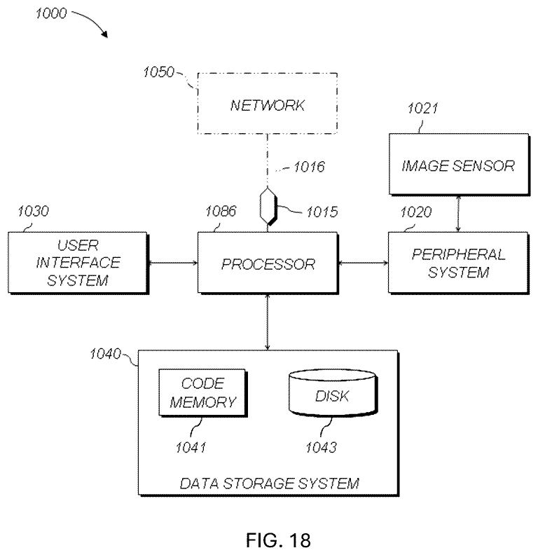

It should be appreciated that the above-described method is carried out by a computing system including a processor configured to execute instructions maintained on a non-transitory memory. Referring to FIG. 18, an example of a computer system is provided that can carry out the method of the present disclosure. Thus, FIG. 18 provides a high-level diagram showing the components of an exemplary data-processing system 1000 for analyzing data and performing other analyses described herein, and related components. The system includes a processor 1086, a peripheral system 1020, a user interface system 1030, and a data storage system 1040. The peripheral system 1020, the user interface system 1030 and the data storage system 1040 are communicatively connected to the processor 1086. Processor 1086 can be communicatively connected to network 1050 (shown in phantom), e.g., the Internet or a leased line, as discussed below. The imaging described in the present disclosure may be obtained using imaging sensors 1021 and/or displayed using display units (included in user interface system 1030) which can each include one or more of systems 1086, 1020, 1030, 1040, and can each connect to one or more network(s) 1050. Processor 1086, and other processing devices described herein, can each include one or more microprocessors, microcontrollers, field-programmable gate arrays (FPGAs), application-specific integrated circuits (ASICs), programmable logic devices (PLDs), programmable logic arrays (PLAs), programmable array logic devices (PALs), or digital signal processors (DSPs).

Processor 1086 can implement processes of various aspects described herein. Processor 1086 can be or include one or more device(s) for automatically operating on data, e.g., a central processing unit (CPU), microcontroller (MCU), desktop computer, laptop computer, mainframe computer, personal digital assistant, digital camera, cellular phone, smartphone, or any other device for processing data, managing data, or handling data, whether implemented with electrical, magnetic, optical, biological components, or otherwise. Processor 1086 can include Harvard-architecture components, modified-Harvard-architecture components, or Von-Neumann-architecture components.

The phrase “communicatively connected” includes any type of connection, wired or wireless, for communicating data between devices or processors. These devices or processors can be located in physical proximity or not. For example, subsystems such as peripheral system 1020, user interface system 1030, and data storage system 1040 are shown separately from the data processing system 1086 but can be stored completely or partially within the data processing system 1086.

The peripheral system 1020 can include one or more devices configured to provide digital content records to the processor 1086. For example, the peripheral system 1020 can include digital still cameras, digital video cameras, cellular phones, or other data processors. The processor 1086, upon receipt of digital content records from a device in the peripheral system 1020, can store such digital content records in the data storage system 1040.

The user interface system 1030 can include a mouse, a keyboard, another computer (connected, e.g., via a network or a null-modem cable), or any device or combination of devices from which data is input to the processor 1086. The user interface system 1030 also can include a display device, a processor-accessible memory, or any device or combination of devices to which data is output by the processor 1086. The user interface system 1030 and the data storage system 1040 can share a processor-accessible memory.

In various aspects, processor 1086 includes or is connected to communication interface 1015 that is coupled via network link 1016 (shown in phantom) to network 1050. For example, communication interface 1015 can include an integrated services digital network (ISDN) terminal adapter or a modem to communicate data via a telephone line; a network interface to communicate data via a local-area network (LAN), e.g., an Ethernet LAN, or wide-area network (WAN); or a radio to communicate data via a wireless link, e.g., WiFi or GSM. Communication interface 1015 sends and receives electrical, electromagnetic or optical signals that carry digital or analog data streams representing various types of information across network link 1016 to network 1050. Network link 1016 can be connected to network 1050 via a switch, gateway, hub, router, or other networking device.

Processor 1086 can send messages and receive data, including program code, through network 1050, network link 1016 and communication interface 1015. For example, a server can store requested code for an application program (e.g., a JAVA applet) on a tangible non-volatile computer-readable storage medium to which it is connected. The server can retrieve the code from the medium and transmit it through network 1050 to communication interface 1015. The received code can be executed by processor 1086 as it is received or stored in data storage system 1040 for later execution.

Data storage system 1040 can include or be communicatively connected with one or more processor-accessible memories configured to store information. The memories can be, e.g., within a chassis or as parts of a distributed system. The phrase “processor-accessible memory” is intended to include any data storage device to or from which processor 1086 can transfer data (using appropriate components of peripheral system 1020), whether volatile or nonvolatile; removable or fixed; electronic, magnetic, optical, chemical, mechanical, or otherwise. Exemplary processor-accessible memories include but are not limited to: registers, floppy disks, hard disks, tapes, bar codes, Compact Discs, DVDs, read-only memories (ROM), erasable programmable read-only memories (EPROM, EEPROM, or Flash), and random-access memories (RAMs). One of the processor-accessible memories in the data storage system 1040 can be a tangible non-transitory computer-readable storage medium, i.e., a non-transitory device or article of manufacture that participates in storing instructions that can be provided to processor 1086 for execution.

In an example, data storage system 1040 includes code memory 1041, e.g., a RAM, and disk 1043, e.g., a tangible computer-readable rotational storage device such as a hard drive. Computer program instructions are read into code memory 1041 from disk 1043. Processor 1086 then executes one or more sequences of the computer program instructions loaded into code memory 1041, as a result performing process steps described herein. In this way, processor 1086 carries out a computer implemented process. For example, steps of methods described herein, blocks of the flowchart illustrations or block diagrams herein, and combinations of those, can be implemented by computer program instructions. Code memory 1041 can also store data or can store only code.

Various aspects described herein may be embodied as systems or methods. Accordingly, various aspects herein may take the form of an entirely hardware aspect, an entirely software aspect (including firmware, resident software, micro-code, etc.), or an aspect combining software and hardware aspects. These aspects can all generally be referred to herein as a “service,” “circuit,” “circuitry,” “module,” or “system.”

Furthermore, various aspects herein may be embodied as computer program products including computer readable program code stored on a tangible non-transitory computer readable medium. Such a medium can be manufactured as is conventional for such articles, e.g., by pressing a CD-ROM. The program code includes computer program instructions that can be loaded into processor 1086 (and possibly also other processors), to cause functions, acts, or operational steps of various aspects herein to be performed by the processor 1086 (or other processors). Computer program code for carrying out operations for various aspects described herein may be written in any combination of one or more programming language(s) and can be loaded from disk 1043 into code memory 1041 for execution. The program code may execute, e.g., entirely on processor 1086, partly on processor 1086 and partly on a remote computer connected to network 1050, or entirely on the remote computer.

Those having ordinary skill in the art will recognize that numerous modifications can be made to the specific implementations described above. The implementations should not be limited to the particular limitations described. Other implementations may be possible.

1. A method of identifying musical performance errors, comprising:
receiving a performance audio file associated with a musical performance including possible musical errors;
receiving a reference score audio file associated with a baseline performance free of any musical errors;
segmenting each of the performance and reference score audio files into a plurality of windows;
for each window, applying a model to thereby detect any musical errors that exist between the performance and reference score audio files; and
using a visual or audio indicator communicating the detected musical error to a user.

2. The method of claim 1, wherein said windows are between about 10 ms and 2 seconds.

3. The method of claim 1, wherein said detected errors is based on i) missed notes, ii) extra notes, and iii) correct notes.

4. The method of claim 1, wherein said communication of detected errors is based on displaying vocabulary-based tokens on a display unit.

5. The method of claim 1, wherein said communication of detected errors is based on visual indicators.

6. The method of claim 5, wherein the visual indicators includes three lights: i) a first light for a missed note, ii) a second light for an extra note, and iii) a green light for a correct note.

7. The method of claim 1, wherein said communication of detected errors is based on audio indicators.

8. The method of claim 7, where the audio indicators includes three tones: i) a first tone for a missed note, ii) a second tone for an extra note, and iii) no tones for a correct note.

9. The method of claim 1, wherein the model is a machine learning model, including a neural network, wherein the neural network has been trained using i) an audio file without any errors, and ii) the audio file with synthetic errors placed therein.

10. The method of claim 9, wherein during the training of the neural network, output of the neural network is compared with expected output during an iterative optimization process whereby the neural network is updated after each iteration, wherein the optimization includes gradient descent.

11. A system of identifying musical performance errors, comprising:
an audio input device configured to convert audible sounds to electronic signals presented in one or more audio files;
a processor executing software housed on a non-transient memory, the execution of the software enables the processor to:
receive a performance audio file associated with a musical performance including possible musical errors;
receive a reference score audio file associated with a baseline performance free of any musical errors;
segment each of the performance and reference score audio files into a plurality of windows; and
for each window, apply a model to thereby detect any musical errors that exist between the performance and reference score audio files; and
a visual or audio indicator in communication with the processor to thereby communicate the detected musical error to a user.

12. The system of claim 11, wherein said windows are between about 10 ms and 2 seconds.

13. The system of claim 11, wherein said detected errors is based on i) missed notes, ii) extra notes, and iii) correct notes.

14. The system of claim 11, wherein said communication of detected errors is based on displaying vocabulary-based tokens on a display unit.

15. The system of claim 11, wherein said communication of detected errors is based on visual indicators.

16. The method of claim 15, wherein the visual indicators includes three lights: i) a first light for a missed note, ii) a second light for an extra note, and iii) a green light for a correct note.

17. The system of claim 11, wherein said communication of detected errors is based on audio indicators.

18. The method of claim 17, where the audio indicators includes three tones: i) a first tone for a missed note, ii) a second tone for an extra note, and iii) no tones for a correct note.

19. The system of claim 11, wherein the model is a machine learning model, including a neural network, wherein the neural network has been trained using i) an audio file without any errors, and ii) the audio file with synthetic errors placed therein.

20. The method of claim 19, wherein during the training of the neural network, output of the neural network is compared with expected output during an iterative optimization process whereby the neural network is updated after each iteration, wherein the optimization includes gradient descent.
